(19) United States
(12) Patent Application Publication
(10) Pub. No.: US 2011/0199286 A1
(43) Pub. Date: Aug. 18, 2011

(54) Spherical Electronic LCD Display

(76) Inventor: Robin Dziama, Tazewell, TN (US)

(21) Appl. No.: 12/705,573

(22) Filed: Feb. 13, 2010

(51) Int. Cl. G09G 3/32

(52) U.S. Cl. 345/82

(57) ABSTRACT

A spherical electronic display is disclosed that includes a spherical display screen that is able to display electronically generated images on its surface using electronic display technology included in the surface, and an electronic control unit in communication with the spherical display screen, the electronic control unit being able to cause the spherical display screen to display images. The electronically controlled spherical display uses low energy display technology, such as LCD and/or OLED electronics, included within the spherical surface. This approach avoids the need to project images onto a spherical screen, and thereby avoids any need for high energy optical projectors and their associated costs and maintenance requirements. The spherical display is connectable to an electronic control unit that can be located either within the sphere or within a support base. The electronic control unit can be a conventional computer or a self-contained, dedicated controller.

### FIELD OF THE INVENTION

The invention generally relates to electronic displays, and more specifically to spherical electronic displays.

### BACKGROUND OF THE INVENTION

Most types of information are preferably displayed on a flat surface, including books and most other printed matter, as well as television, movies, and most electronically displayed information such as computer display screens and information displayed on PDA's, MP3 players, cellular telephones, and such like. However, there are certain types of information that are preferably displayed on a spherical surface. The most common example is information pertaining to the earth's surface, which is often displayed on a sphere, or “globe.” Such so-called “world globes,” with maps of the world printed thereon, have long been known. Often, a world globe is mounted on a support that allows movement of the globe about at least one rotational axis, and some globes are mounted on supports that allow rotation about two axes, or about any arbitrary axis, so as to allow the globe to be positioned in any desired orientation.

World globes are used to display many different types of information pertaining to the earth's surface, including geographic features, ancient and modern political boundaries, ocean currents, population densities, agricultural crop distributions, and such like. This presents a problem for traditional, printed world globes, because it is not possible for a single globe to simultaneously display all of the types of information that might be desirable, for example in a school classroom. This problem is increased even further if display of non-terrestrial, spherical information is desired, such as global maps of the moon and/or other planets, or a global representation of star constellations.

A plurality of world globes can be provided so as to display all of the desired information. However, this approach is inconvenient, requires a large amount of storage space, and does not provide for overlap and comparison of different types of information.

Another disadvantage of traditional world globes is that the density of information presented on the globe can be very high, making it difficult to locate desired items of information. Also, traditional world globes do not provide an ability to display transitory information on a spherical surface, such as current weather patterns, current locations of satellites, and such like.

A spherical electronic display can be used to overcome many of the limitations cited above. A computer or similar control device can be used to select and generate virtually any desired spherical display information, and cause it to be displayed on the surface of the spherical electronic display in any desired orientation. The control device can also be used to highlight desired information that might otherwise be difficult to locate on the spherical display. In addition, a spherical electronic display can be used to present time-varying information, such as indicating the earth's rotation, boundaries between day and night regions, weather patterns, satellite locations, eclipses, and such like. Some known spherical electronic displays also include touch-screen capability so as to facilitate control of certain display features.

However, spherical electronic displays are generally complex in design, expensive to manufacture, and high in energy use, and they require significant maintenance to remain in operation. Typically, images are projected onto a spherical display “screen” by multiple projectors located either outside or inside of the sphere. The projectors must be carefully aligned, and must transmit a very bright image. If the projectors are external to the screen, then observers of the display tend to block the light and cast shadows onto the spherical screen. If the projectors are internal to the screen, then they must project a very bright light so as to penetrate the translucent screen and provide a bright image to observers. Generation of such bright images typically requires the use of high voltages, and consequent wear and replacement of lamps, high voltage power supplies, and/or other projector components.

Also, spherical displays are restricted to displaying information on a single spherical surface, and cannot easily provide a sense of depth. For example, it is difficult using such displays to provide a realistic, visually appealing presentation of clouds, satellites, stars, airline routes, and other features that are generally located above the earth's surface.

### SUMMARY OF THE INVENTION

An electronically controlled spherical display is claimed that is able to display images on a spherical surface using low energy display technology, such as LCD and/or OLED electronics, included within the spherical surface. This approach avoids the need to project images onto a spherical screen, and thereby avoids any need for high energy optical projectors and their associated costs and maintenance requirements.

The claimed spherical display is connectable to an electronic control unit that can be located either within the sphere or within a support base. The electronic control unit can be a conventional computer or a self-contained, dedicated controller. Communication with the controller can be by wired and/or by wireless means.

Further preferred embodiments include a touch screen layer that provides touch screen control of the display, and some preferred embodiments include a display stand with motors that allow the physical orientation of the spherical display to be electronically controlled.

In some preferred embodiments, at least one layer of the spherical display is transparent, thereby providing an additional dimension of depth by enabling the transparent layer to electronically superimpose displayed information on top of other information displayed below the transparent layer. These embodiments use liquid crystal display (LCD) technology or optical light emitting diode (OLED) technology to electronically generate the images, while remaining transparent in regions where images are not being displayed.

In some of these embodiments, a traditional, opaque object such as a printed world globe is contained within the transparent spherical display, thereby minimizing cost while allowing the transparent display to superimpose onto the conventional globe selected information such as national boundaries, crop patterns, weather patterns, satellite positions, and other relevant information. In some of these embodiments, the hollow, transparent display is able to provide a sense of depth by displaying clouds, satellites, and other items physically above the surface of the traditional globe. The printed globe can be used in a conventional fashion in these configurations when the spherical display is not active.

In other of these embodiments, an opaque, electronic spherical display is overlaid by the transparent electronic spherical display, thereby allowing all displayed information to be electronically selected and controlled, while at the same time enabling display of information on at least two concentric levels, so as to provide an additional sense of depth.

### BRIEF DESCRIPTION OF THE DRAWINGS

The invention will be more fully understood by reference to the detailed description, in conjunction with the following figures, wherein:

FIG. 1A is a perspective view of a preferred embodiment that includes an opaque spherical display with a control unit mounted in the base of a support stand and in wireless communication with a control computer;

FIG. 1B is a perspective view of an embodiment similar to FIG. 1A, but including a transparent touch-screen sphere surrounding the spherical display;

FIG. 1C is a perspective view of a preferred embodiment that includes a hollow transparent spherical electronic display screen surrounding a conventional, printed world globe, with an electronic control unit mounted in the base of a support stand and in wireless communication with a control computer;

FIG. 2A is a front view of a preferred embodiment that includes a hollow transparent spherical electronic display surrounding an opaque electronic spherical display, wherein the hollow transparent display is providing a real-time display of weather patterns above the surface of the a world globe displayed by the opaque spherical electronic display;

FIG. 2B is a front view of the embodiment of FIG. 2A, wherein the hollow transparent spherical display is displaying a projection of the orbit of a space shuttle above the surface of the world globe displayed by the opaque electronic spherical display;

FIG. 2C is a front view of the embodiment of FIG. 2A, wherein the hollow transparent spherical display is displaying a projection of star constellations above the surface of the world globe displayed by the opaque electronic spherical display;

FIG. 3 is a front view of an embodiment that includes an opaque spherical electronic display contained within a transparent spherical electronic display layer, showing a person using a spherical touch screen layer to select a map of Mars from a displayed list of choices;

FIG. 4A is a cutaway view of the embodiment of FIG. 3, showing the transparent spherical display layer, the opaque electronic spherical display beneath the transparent spherical display layer, and an electronic control unit mounted inside the opaque electronic spherical display by a support structure, the electronic control unit being in wireless communication with a computer; and

FIG. 4B is a cutaway view of an embodiment that includes a touch screen layer and a plurality of concentric transparent spherical display layers surrounding an opaque electronic spherical display, and an electronic control unit mounted within the opaque electronic spherical display, the electronic control unit being in wireless communication with a computer.

### DETAILED DESCRIPTION OF PREFERRED EMBODIMENTS

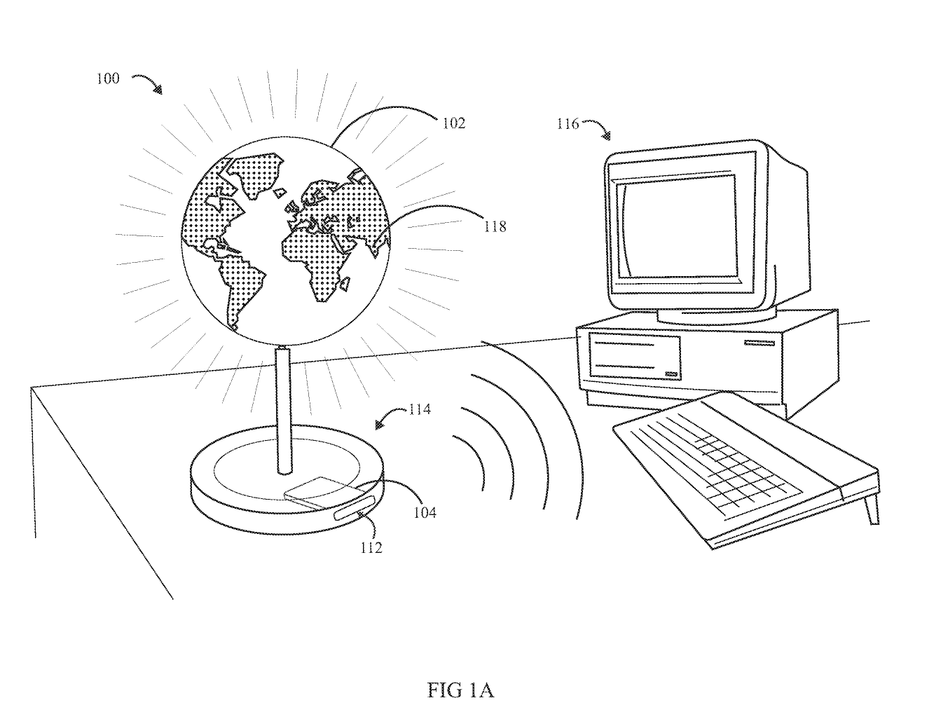

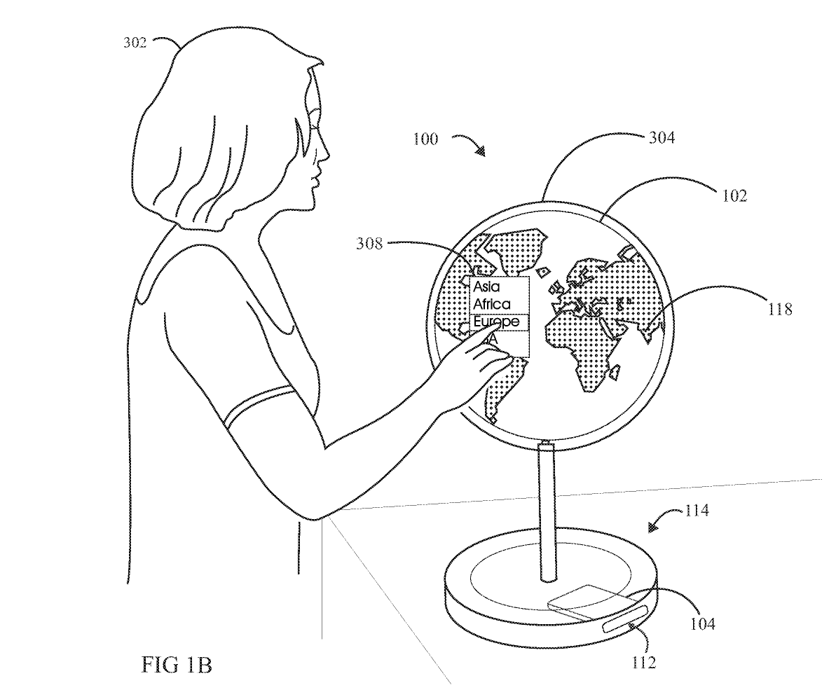

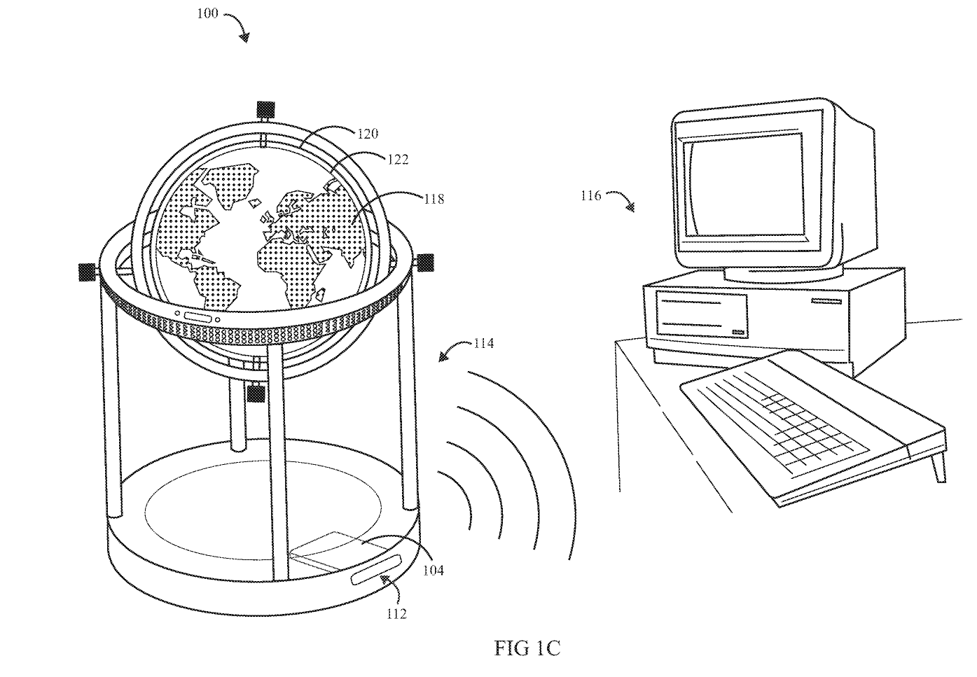

With reference to FIG. 1A, the invention is an electronically controlled spherical display 100 that is able to display images on a spherical surface 102 by including low energy display technology, such as LCD and/or OLED electronics, within the spherical surface 102. The screen 102 is preferably able to display images in color. Power is supplied to the screen either by an electrical cord and power supply (not shown), or by batteries (not shown) contained either within the spherical display 102 or in a supporting stand 114.

In the embodiment of FIG. 1A, an electronic control unit 104 is located in a drawer 112 in a support base 114 that supports the spherical display screen 102. The control unit 104 is in wireless communication with a control computer 116. In similar embodiments, the control unit 104 is in wired communication with the control computer 116. In other embodiments, the computer 116 is included within the base unit 114, or within the spherical display screen 102. In FIG. 1A, the spherical display screen is functioning as a world globe by displaying an image of all the continents 118 of the earth.

FIG. 1B illustrates an embodiment similar to FIG. 1A, but including a hollow, transparent touch-screen 304 surrounding the spherical display screen 102. The touch screen 304 allows a user 302 to control what is displayed on the screen 102 simply by touching the touch screen 304. For example, in FIG. 1B, the user 302 is selecting a continent from a displayed list 308, so as to shift the displayed image of the world until the selected continent is positioned on the portion of the screen 102 nearest to the user.

In the embodiment of FIG. 1C, the electronic display 100 of the present invention includes a hollow, transparent spherical display screen 120 that surrounds a conventional, printed world globe 122, and is able to superimpose information onto the convention globe 122, such as current and historic national boundaries, crop locations, weather patterns, satellite locations, day/night boundaries, and other information. In preferred embodiments, the hollow spherical display screen 120 is openable so as to allow placement of display items such as the world globe 122 within the hollow spherical display screen 120.

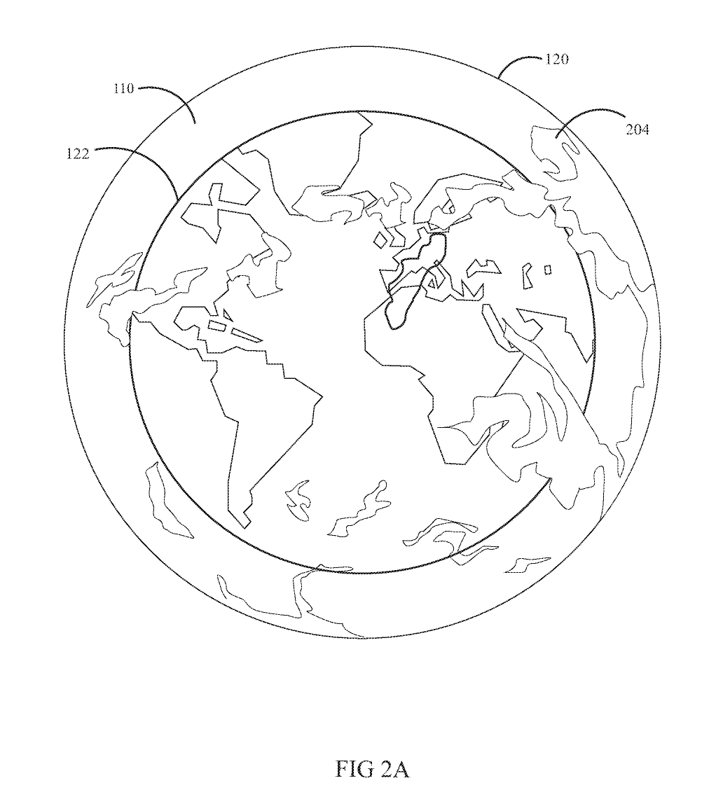

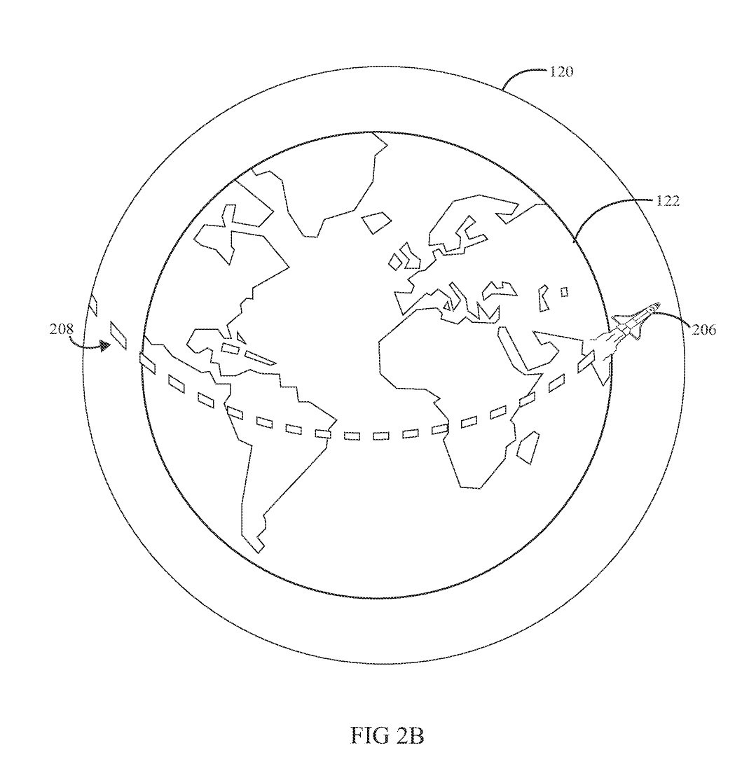

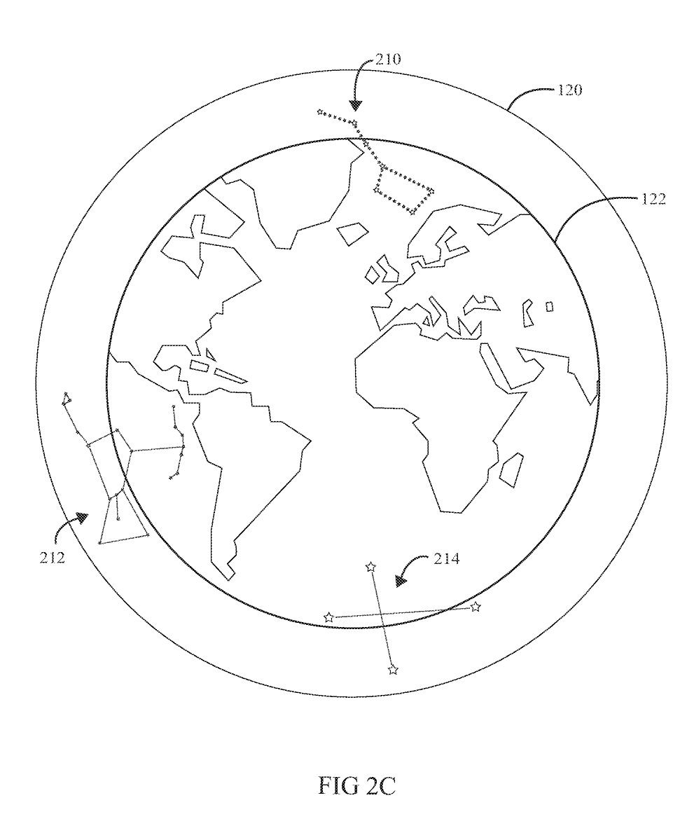

FIGS. 2A, 2B and 2C illustrate front views of a preferred embodiment in which a hollow, transparent spherical display screen 120 is presenting electronically generated images 204-214 above the surface of an opaque spherical display that is displaying an image of a world globe 122. The hollow spherical display screen 120 is able to display electronically generated images 204-214 while remaining transparent in regions 110 where an image 204-214 is not being displayed. When the hollow spherical display screen 120 is not in use, it is entirely transparent, and thereby allows the displayed image of the world globe 122 to be used in a conventional fashion.

In FIG. 2A, FIG. 2B, and FIG. 2C, the hollow spherical display screen 102 is superimposing images of clouds 204 (FIG. 2A), a space shuttle 206 propagating through an orbital path 208 (FIG. 2B), and star constellations 210, 212, 214 (FIG. 2C) above the world globe 122 displayed by the opaque spherical display contained within the hollow spherical display screen 120.

In the embodiment of FIG. 2A-2C, the hollow spherical display 120 layer causes images 204-214 to appear above the surface of the world globe 122, thereby providing a sense of depth when displaying weather patterns 204, satellite locations, and other relevant information pertaining to phenomena that occur above the surface of the earth. In other embodiments, such as the embodiment of FIG. 1C, the hollow spherical display 120 is only slightly larger in diameter than the world globe 122, thereby causing items such as national boundaries, crop distributions, population densities, and such like to appear superimposed on the surface of the world globe 122. In yet further preferred embodiments, a plurality of nested, hollow spherical displays 120 is provided, so as to enable display of images both superimposed on the world globe 122 and appearing above the surface of the world globe 122.

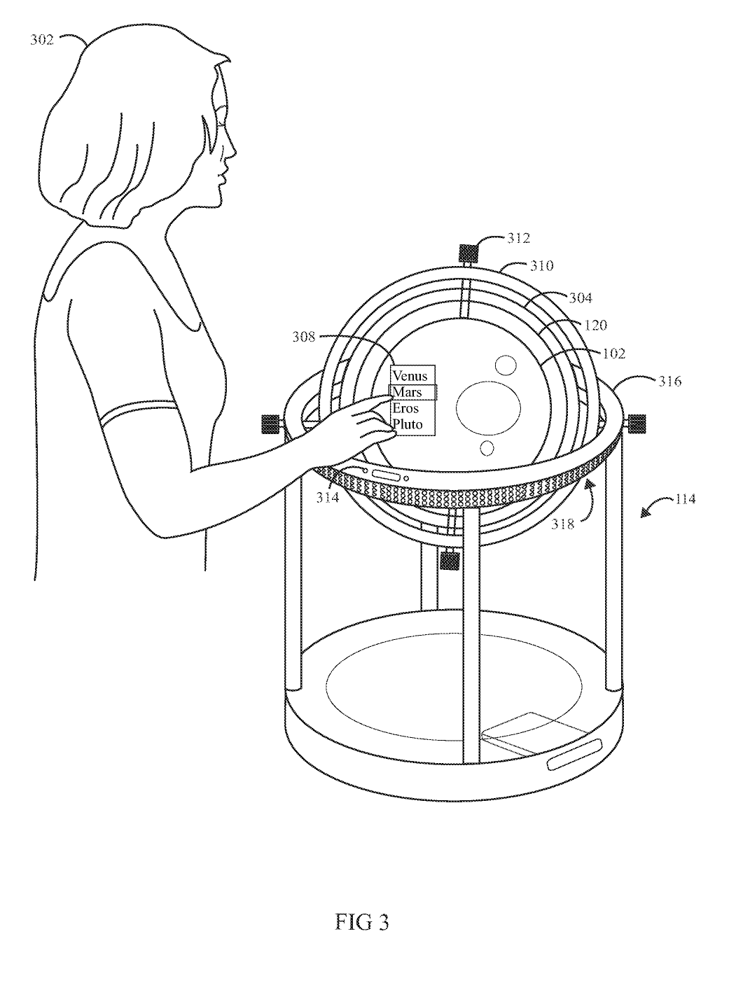

FIG. 3 shows a front view of a preferred embodiment similar to the embodiment of FIG. 2A-2C in which an opaque, spherical electronic display 102 is contained within a transparent, spherical electronic display 120. A touch-screen layer 304 is also included in the embodiment of FIG. 3, the touch-screen layer 304 being located on the outer surface of the transparent, spherical electronic display 120. For purposes of illustration, an exaggerated separation is shown in FIG. 3 between the touch-screen layer 304 and the transparent spherical display layer 120.

FIG. 3 shows a user 302 touching the touch-screen layer 304, and thereby selecting a map of Mars 306 from a list of planets displayed on a display panel 308. This causes the opaque spherical electronic display 102 to display a globe of Mars, while the transparent spherical display layer 120 displays the location of orbiting satellites, moons, and other relevant information about phenomena located above the surface of Mars.

In the embodiment of FIG. 3, the display mount 310 allows the display screen 120 to pivot about two separate axes, and includes stepper motors 312 that are able to physically rotate the display screen 120 to any desired orientation under control of the computer 116. In similar embodiments, the world globe 122, opaque spherical electronic display 102, and/or other item(s) contained within the hollow, transparent electronic display 120 can be physically rotated to desired orientations by motors 312 included with the display 100.

The display mount 310 in the embodiment of FIG. 3 further includes controls 314 that can be actuated by the user 302 so as to control the display of images on at least one of the hollow spherical display screen 120 and on the opaque, spherical display screen 102 contained within the hollow spherical display screen 120. The support base 114 supporting the hollow display screen 120 includes an equatorial shelf 316 with a ring of LED's 318 that can be illuminated so as to draw attention to a certain longitudinal feature such as the day/night boundary or the position of an orbiting moon.

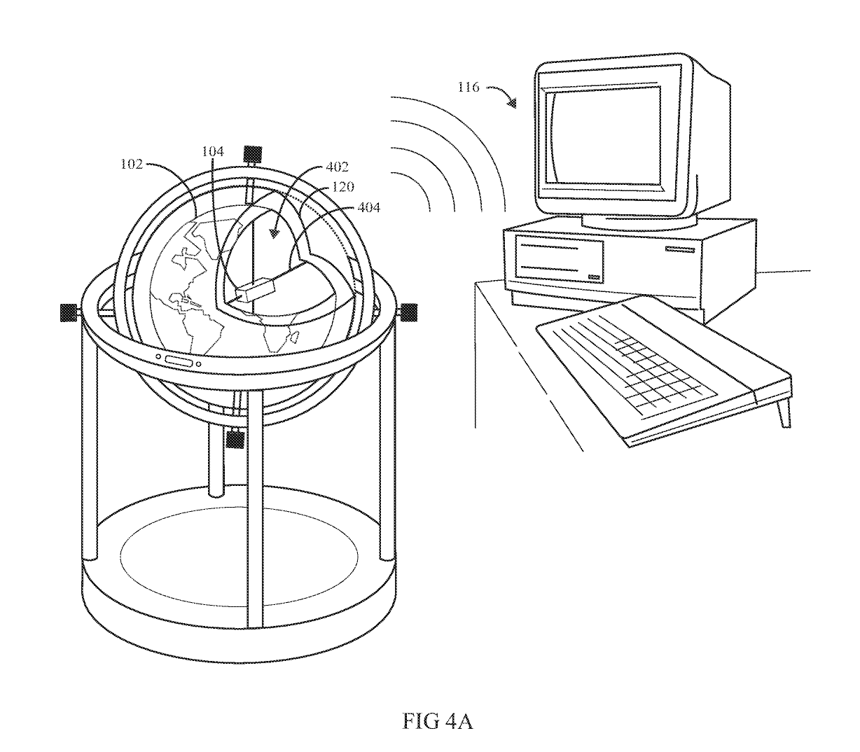

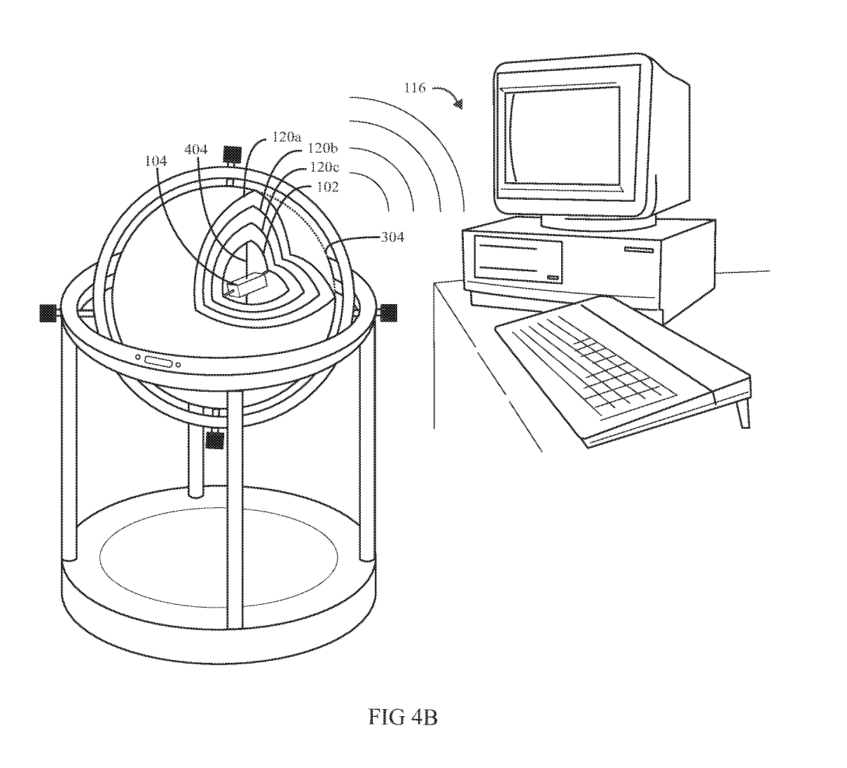

FIG. 4A illustrates a cutaway view of an embodiment that is similar to the embodiment of FIG. 2A, except that the electronic control unit 104 is mounted within the interior 402 of the opaque spherical display screen 102 on a framework 404. In the embodiment of FIG. 4A, the electronic control unit 104 is in wireless communication with the computer 116. In similar embodiments, the electronic control unit is a self-contained, dedicated controller that is controlled by a touch-screen layer 304 accessible to users 302 of the display 100.

FIG. 4B illustrates a cutaway view of a preferred embodiment similar to the embodiment of FIG. 4A, except that a plurality of nested, transparent display layers 120a-120c is included.

Other modifications and implementations will occur to those skilled in the art without departing from the spirit and the scope of the invention as claimed. Accordingly, the above description is not intended to limit the invention except as indicated in the following claims.

What is claimed is:

1. A spherical electronic display comprising:
a spherical display screen that is able to display electronically generated images on its surface using electronic display technology included in the surface; and
an electronic control unit in communication with the spherical display screen, the electronic control unit being able to cause the spherical display screen to display images.

2. The spherical electronic display of claim 1, wherein the electronic display technology includes at least one of:
LCD technology; and
OLED technology.

3. The spherical electronic display of claim 1, wherein the spherical display screen is able to display color images.

4. The spherical electronic display of claim 1, wherein the electronic control unit is located in one of:
the hollow interior of the hollow spherical display screen; and
a support base that supports the hollow spherical display screen.

5. The spherical electronic display of claim 1, wherein the electronic control unit is controllable by a computer.

6. The spherical electronic display of claim 5, wherein the electronic control unit is able to communicate with the computer by at least one of wired and wireless communication.

7. The spherical electronic display of claim 1, further comprising a display mount that is able to support the hollow spherical display screen.

8. The spherical electronic display of claim 7, wherein the display mount is able to support the spherical display screen from at least one of above, below, and to a side of the spherical display screen.

9. The spherical electronic display of claim 8, wherein the display mount includes at least one motor that is able to physically change the orientation of the spherical display screen.

10. The spherical electronic display of claim 9, wherein the motor is a stepper motor.

11. The spherical electronic display of claim 7, wherein the display mount includes controls that can be actuated by a user so as to control the spherical display screen.

12. The spherical electronic display of claim 1, further comprising a spherical touch-screen layer that surrounds the spherical display screen, the touch-screen layer being actuatable by a user so as to control the spherical display screen.

13. The spherical electronic display of claim 1, wherein the electronic control unit includes a memory that is able to contain information suitable for display on the spherical display screen.

14. The spherical electronic display of claim 1, wherein the spherical display screen is hollow and transparent, so that an item contained within the spherical display screen can be viewed through regions of the spherical display screen that are not actively displaying an image.

15. The spherical electronic display of claim 14, wherein the hollow spherical display screen is openable so as to allow at least one of:
placing an item within the hollow spherical display screen;
accessing an item located within the spherical display screen; and
removing an item from the spherical display screen.

16. The spherical electronic display of claim 14, further comprising an opaque, printed spherical object that is contained within the hollow spherical display screen and configured so as to allow the hollow spherical display screen to superimpose images thereupon.

17. The spherical electronic display of claim 14, further comprising an opaque electronic spherical display contained within the hollow spherical display screen and configured so as to allow the hollow spherical display screen to superimpose images thereupon.

18. The spherical electronic display of claim 17, wherein the electronic control unit is further able to control the opaque electronic spherical display.

19. The spherical electronic display of claim 14, wherein the spherical electronic display includes a plurality of nested, hollow, transparent spherical display screens.
